(19) United States
(12) Patent Application Publication
(10) Pub. No.: US 2026/0194440 A1
(43) Pub. Date: Jul. 9, 2026

(54) PARTICLE CHARACTERIZATION IN FLOW CYTOMETRY

(71) Applicant: Beckman Coulter, Inc., Brea, CA (US)

(72) Inventor: Ihor BEREZHNYY, San Jose, CA (US)

(73) Assignee: Beckman Coulter, Inc., Brea, CA (US)

(21) Appl. No.: 19/134,625

(22) PCT Filed: Dec. 6, 2023
(86) PCT No.: PCT/US2023/082703

§ 371 Date: May 30, 2025

Related U.S. Application Data
(60) Provisional application No. 63/386,933, filed on Dec. 12, 2022.

(51) Int. Cl. G01N 15/1429; G01N 15/0205; G01N 15/10; G01N 15/14

(52) U.S. Cl. CPC G01N 15/1429; G01N 15/0205; G01N 15/1459; G01N 2015/1006; G01N 2015/1493

(57) ABSTRACT

A detection system for analyzing particles is described. The detection system detects radiated light as a particle passes through a light beam and generates a waveform as a digital representation of the radiated light detected from the particle. The detection system performs a waveform regression analysis on the waveform to obtain coefficients for characterizing the waveform and assigns one or more characteristics to the particle based on the coefficients.

### CROSS-REFERENCE TO RELATED APPLICATION

This application is being filed on Dec. 6, 2023, as a PCT International application and claims priority to and the benefit of U.S. Provisional Application Ser. No. 63/386,933, filed Dec. 12, 2022, the disclosure of which is hereby incorporated by reference herein in its entirety.

### BACKGROUND

In flow cytometry, particles are arranged in a sample stream and pass through one or more excitation light beams with which the particles interact. Data including light that is scattered and/or emitted by the particles from interaction with the excitation light beams is collected and analyzed to characterize and differentiate the particles. In a sorting flow cytometer, particles may be extracted out of the sample stream after having been characterized by their interaction with the one or more excitation beams, and thereby sorted into different groups.

In some instances, flow cytometry fails to make effective use of all the data collected from the particles. For example, flow cytometry can fail to analyze more complex aspects such as the shapes of waveforms generated from the collected data. This can cause potentially valuable information to be ignored from a flow cytometry analysis.

### SUMMARY

The present disclosure generally relates to particle characterization in flow cytometry. In one possible configuration, a waveform regression analysis is performed to obtain coefficients characterizing radiated light detected from particles passing through a light beam, and one or more characteristics are assigned to the particles based on the coefficients. Various aspects are described in this disclosure, which include, but are not limited to, the following aspects.

One aspect relates to a detection system for analyzing particles, the detection system comprising: one or more processing devices; and a memory storage device storing instructions which, when executed by the one or more processing devices, cause the one or more processing devices to: detect radiated light as a particle passes through a light beam; generate a waveform as a digital representation of the radiated light; perform a waveform regression analysis on the waveform to obtain coefficients characterizing the waveform; and assign one or more characteristics to the particle based on the coefficients.

Another aspect relates to a method of characterizing a particle using a flow cytometer, the method comprising: detecting radiated light as the particle passes through a light beam; generating a waveform as a digital representation of the radiated light; performing a waveform regression analysis on the waveform to obtain coefficients characterizing the waveform; and assigning one or more characteristics to the particles based on the coefficients.

Another aspect relates to a flow cytometer, comprising: a light emitting unit generating an excitation light beam; a focal lens focusing the excitation light beam at an interrogation zone; a flow chamber for streaming particles through the interrogation zone; a light collection unit detecting radiated light from the particles passing through the excitation light beam; and a computing system configured to: generate a waveform as a digital representation of the radiated light detected from the particles passing through the excitation light beam; perform a waveform regression analysis on the waveform to obtain coefficients characterizing the waveform; and assign one or more characteristics to the particles based on the coefficients.

### DESCRIPTION OF THE FIGURES

The following drawing figures, which form a part of this application, are illustrative of the described technology and are not meant to limit the scope of the disclosure in any manner.

FIG. 1 schematically illustrates an example of a detection system for detecting and analyzing particles.

FIG. 2 schematically illustrates an example of a method of characterizing particles using the detection system of FIG. 1.

FIG. 3 illustrates an example of a waveform generated by the method of FIG. 2.

FIG. 4 illustrates an example of detecting an amplitude of the waveform of FIG. 3.

FIG. 5 shows a detailed view of the amplitude depicted in FIG. 4.

FIG. 6 illustrates a waveform generated from a side scatter detection channel of the detection system of FIG. 1.

FIG. 7 illustrates a waveform generated from a fluorescence detection channel of the detection system of FIG. 1.

FIG. 8 graphically illustrates an example showing a threshold superimposed on a waveform determined from data points collected by the detection system of FIG. 1.

FIG. 9 illustrates an example of detecting a baseline of the waveform of FIG. 3.

FIG. 10 shows a detailed view of the baseline depicted in FIG. 9.

FIG. 11 graphically illustrates an example of skewness detection including a waveform generated from experimental data collected by the detection system of FIG. 1.

FIG. 12 schematically illustrates an example of a computing system for implementing aspects of the detection system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

An example detection system is described herein for use in a flow cytometry analyzer. The present disclosure is not limited to the illustrated detection system, but may be applied to a flow cytometry analyzer with other structure or other types of detection systems. In particular, the present disclosure can be applied to various types of sample processing instruments for detecting, sorting, or otherwise processing particles.

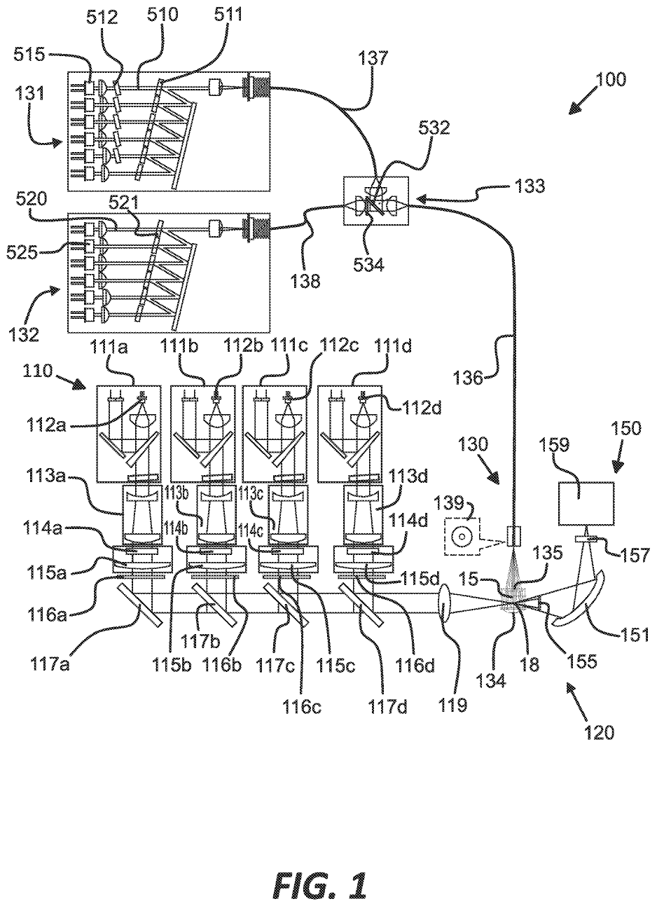

FIG. 1 schematically illustrates an example of a detection system 100 for detecting and analyzing particles. In some examples, the detection system 100 is incorporated into a flow cytometer and/or a sorting flow cytometer. As shown in FIG. 1, the detection system 100 includes a light emitting unit 110 that emits one or more excitation light beams, and a light collection unit 120 that detects light scatter and emission from particles resulting from the projection of the one or more excitation light beams on the particles.

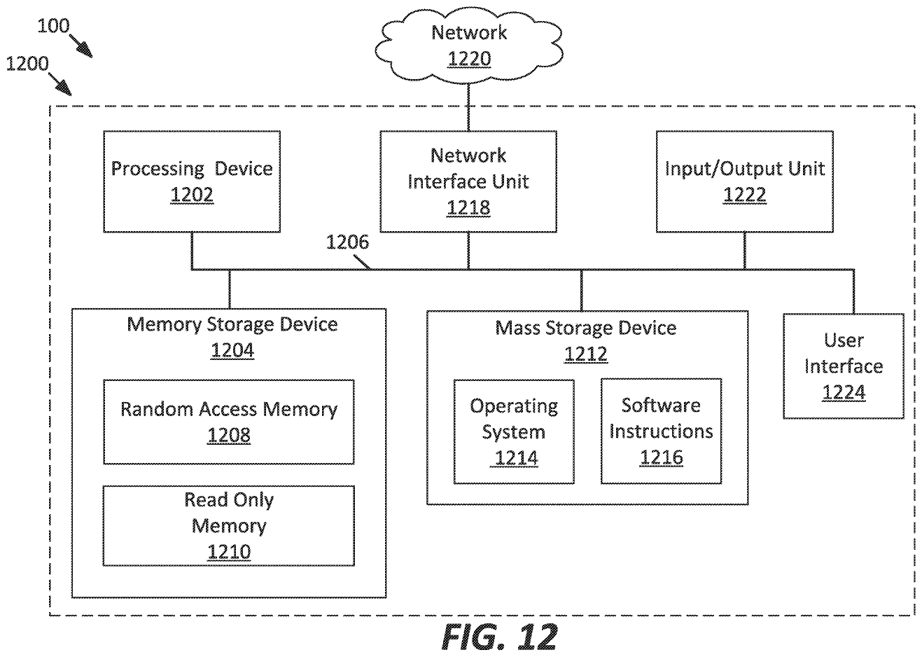

The one or more excitation light beams from the light emitting unit 110 project onto the particles as they flow through an interrogation zone 18 in a flow chamber 15. The light collection unit 120 collects light scatter and emission from the particles for analysis by a computing system 1200, which is shown and described in more detail with reference to FIG. 12.

The light emitting unit 110 includes multiple light sources, such as the light sources 111a, 111b, 111c, and 111d shown in FIG. 1. As an illustrative examples, the light sources 111a-111d can include lasers. The light sources 111a-111d are each configured to emit excitation light beams with different wavelengths, for example, 405 nm, 488 nm, 561 nm, and 638 nm. In the example shown in FIG. 1, the light sources 111a-111d are arranged in parallel. The number, the type, and the arrangement of the light sources are not limited to the example shown and described in FIG. 1, and may be changed as needed. For example, the system may include three, five, six, or any other suitable number of light sources.

The light emitting unit 110 further includes a focal lens 119. The focal lens 119 is configured to focus the excitation light beams for high intensity scatter detection from the particles. For example, the excitation light beams emitted by the light sources 111a-111d pass through the focal lens 119, which focuses the excitation light beams in the interrogation zone 18 of the flow chamber 15. The interrogation zone 18 may also be referred to as a focus point where the focused excitation light beams meet a core sample stream in the detection system 100.

Dichroic mirrors 117a, 117b, 117c, and 117d are arranged between the focal lens 119 and the respective light sources 111a-111d. Each of the dichroic mirrors 117a-117d is configured to reflect a light beam of a corresponding one of the light sources 111a-111d and transmit the light beams of the other light sources. The dichroic mirrors 117a-117d are selected and configured according to the wavelengths of the light beams emitted by the respective light sources 111a-111d. For example, the dichroic mirror 117a reflects light of the wavelength emitted by the light source 111a toward the focal lens 119, the dichroic mirror 117b reflects light of the wavelength emitted by the light source 111b toward the focal lens 119 and transmits light of the wavelength emitted by the light source 111a, the dichroic mirror 117c reflects light of the wavelength emitted by the light source 111c toward the focal lens 119 and transmits light of the wavelengths emitted by the light sources 111a and 111b, and the dichroic mirror 117d reflects light of the wavelength emitted by the light source 111d toward the focal lens 119 and transmits light of the wavelengths emitted by the light sources 111a, 111b, and 111c.

The light beams emitted by the light sources 111a-111d are reflected by or transmitted through the dichroic mirrors 117a-117d to form collinear beams. The collinear beams share an optical axis, and provide a confocal point of multiple light sources by focusing on the same interrogation point. The dichroic mirrors 117a-117d are adjustable in their positions or orientations, such that they can be used to adjust the position of the focus point of the light beams, especially, the position on a plane perpendicular to the optical axis.

Lenses 115a-115d are arranged between the respective light sources 111a-111d and the respective dichroic mirrors 117a-117d. In some examples, the lenses 115a-115d are long-focus lens. In some examples, the lenses 115a-115d are spherical lenses. In other examples, the lenses 115a-115d are aspheric lenses. Each of the lenses 115a-115d can convert light beams into parallel beams. In the example shown in FIG. 1, each of the lenses 115a-115d is in the form of planoconvex lens with a flat surface and a convex surface opposite to each other.

The lenses 115a-115d are adjustable in their positions or orientations to adjust the position of the focus point of the light beams, especially, the position on the plane perpendicular to the optical axis. Generally, the dichroic mirrors 117a-117d can be used to roughly adjust the position of the focus point of the light beams, whereas the lenses 115a-115d can be used to finely adjust the position of the focus point of the light beams.

The number, the type, and the arrangement of the dichroic mirrors 117a-117d and the lenses 115a-115d may be changed as needed, and are not limited to the example illustrated herein. Also, the dichroic mirrors 117a-117d and the lenses 115a-115d can be replaced with other optical elements or optical modules with similar functions.

Beam expanders 113a-113d are arranged between the respective light sources 111a-111d and the respective lenses 115a-115d. Each of the beam expanders 113a-113d can change a sectional dimension and a divergence angle of a light beam. As such, each of the beam expanders 113a-113d are configurable according to a desired size of a spot of a light beam.

The light beams irradiated on the particles by the focal lens 119 have a spot size that allows for more concentrated light beams with a higher power density. This can increase intensity of the light beams irradiated on the particles, and ultimately the intensity of the optical signals collected from the particles. This can improve the efficiency of collecting the optical signals, and thereby provide higher resolution and higher sensitivity for nanoparticle detection.

In the example shown in FIG. 1, the light sources 111a-111d are in the form of lasers that include respective laser diodes 112a-112d. As further shown in the example of FIG. 1, half-wave plates 116a-116d are provided between the dichroic mirrors 117a-117d and the lenses 115a-115d, respectively. The spot of the light beam can be reduced by orientation of the light sources 111a-111d and by use of the half-wave plates 116a-116d.

As further shown in FIG. 1, cylindrical lenses 114a-114d are provided between the respective beam expanders 113a-113d and the respective lenses 115a-115d. The horizontal size of the spot of the light beam focused on the flow chamber 15 can be adjusted by replacing the cylindrical lenses 114a-114d with replacement cylindrical lenses having different curvatures. The power of some or all the light sources 111a-111d can also be increased. The increased power of the light sources 111a-111d can also improve detection sensitivity.

Each of the beam expanders 113a-113d is formed of a first optical part and a second optical part. In the example shown in FIG. 1, each of the beam expanders 113a-113d includes a concave lens adjacent to the corresponding light source as the first optical part, and further includes a convex lens away from the corresponding light source as the second optical part. Each of the beam expanders 113a-113d is not limited to the example shown in FIG. 1. The beam expanders 113a-113d may be formed of any suitable optical lens or lens group. For example, each of the first optical part and the second optical part can be selected from one of a convex lens, a convex lens group, a concave lens, and a concave lens group.

For each of the beam expanders 113a-113d, the distance between the first optical part (e.g., the concave lens) and the second optical part (e.g., the convex lens) is adjustable. This allows for adjustment of a waist position (the focus point) of the light beam on the optical axis.

As described above, by adjusting the dichroic mirrors 117a-117d, the lenses 115a-115d, and the beam expanders 113a-113d, the individual light beams can be focused at the desired interrogation point, and multiple light beams can be focused at the same interrogation point. It should be understood that the position of the focus point of the light beams may be adjusted by adopting any other optical element or in any other adjustment manner. One or more adjustments to the dichroic mirrors 117a-117d, the lenses 115a-115d, and the beam expanders 113a-113d may be made manually, or may be made electronically using a computing device (e.g., a controller) that is associated with one or more actuators coupled to these components.

The light collection unit 120 includes a side collection unit 130 and a forward collection unit 150. The side collection unit 130 collects side scattered light and fluorescent light scattered or emitted from the particles in the sample as they are irradiated by the excitation light beams while passing through the flow chamber 15. The optical axis of light beams collected from the particles by the side collection unit 130 is approximately perpendicular to, or about 90 degrees, from the optical axis of the light beams emitted from the light sources 111a-111d and directed by the dichroic mirrors 117a-117d toward the flow chamber 15.

The forward collection unit 150 collects forward scattered light from the particles. The optical axis of light beams collected from the particles by the forward collection unit 150 may be approximately parallel to, or about 0 degrees from, the optical axis of the light beams that are directed toward the flow chamber 15. The side collection unit 130 and the forward collection unit 150 are described in further detail below.

The side collection unit 130 includes an optical focusing lens group including a concave mirror 134 and an aspheric lens 135, a collection fiber 136, a beam splitter 133, a first wavelength division multiplexer 131, and a second wavelength division multiplexer 132. The concave mirror 134 reflects the scattered light and the fluorescent light that diverge in various directions at the interrogation point. The concave mirror 134 and the aspheric lens 135 focus the reflected light onto the collection fiber 136, for example, by focusing on the same point of the collection fiber 136 as shown in the dotted block 139 in FIG. 1. The concave mirror 134 can focus the reflected light on the fiber, while the aspheric lens 135 can make the focal point smaller (i.e., reduce the aberration). To prevent crosstalk, a beam splitter 133 is arranged to separate the scattered light with high intensity from the fluorescent light with low intensity. The separated scattered light and fluorescent light respectively enter the first wavelength division multiplexer 131 and the second wavelength division multiplexer 132 through first and second fibers 137, 138, respectively. Optical signals with different wavelengths are separated in the first wavelength division multiplexer 131 and the second wavelength division multiplexer 132 for analysis. It should be noted that the optical focusing lens group may adopt other optical elements.

The beam splitter 133 includes a dichroic mirror 532 and a notch filter 534. Collected light is directed into the beam splitter toward the dichroic mirror 532 by the collection fiber 136, which may be oriented such that the light beam is directed toward the dichroic mirror 532 at an incident angle of, for example, 45 degrees. The dichroic mirror 532 reflects the side scattered light coming out of the collection fiber 136 such that the side scattered light enters the first wavelength division multiplexer 131 through the first fiber 137.

The fluorescent light coming out of the collection fiber 136 passes through dichroic mirror 532, and is incident to the notch filter 534 at an incident angle of about 90 degrees and then passes through the notch filter 534. The fluorescent light enters the second wavelength division multiplexer 132 through the second fiber 138. The dichroic mirror 532 and the notch filter 534 can each have multiple bands according to the confocal design of the light sources 111a-111d. In this case, the dichroic mirror 532 and the notch filter 534 both have four bands that block four laser wavelengths. The number of bands of the dichroic mirror 532 and the notch filter 534 can correspond to the number of the light sources 111a-111d.

The beam splitter 133 separates the side scattered light with high intensity from the fluorescent light with low intensity, reducing or preventing crosstalk of the side scattered light to the fluorescent light. In addition, by providing the beam splitter, it is possible to separate and transmit multiple light beams into two or more wavelength division multiplexers. The optical elements included in the beam splitter 133 and their configuration may be changed, and are not limited to the example shown and described herein.

In some examples, the first wavelength division multiplexer 131 receives the side scattered light beams from the beam splitter 133 via the first fiber 137 and divides optical signals of the side scattered light with different wavelengths from each other. In the first wavelength division multiplexer 131, each optical signal is transmitted along an optical transmission path 510 corresponding to an optical channel of the optical signal.

The first wavelength division multiplexer 131 includes a first filter 511 and a second filter 512 for each optical channel. The first filter 511 and the second filter 512 are arranged at a certain distance from each other along the optical transmission path of the optical channel in a non-parallel manner. Crosstalk between side scattered lights can be reduced or prevented by providing the two filters. The first and second filters 511 and 512 are not arranged in parallel so as to avoid multiple reflections of light between them and achieve a better optical density. Thereafter, the filtered light enters a light detection element 515 (e.g., a photodiode, an avalanche photodiode (APD), a photomultiplier tube) for further processing the light.

The second wavelength division multiplexer 132 receives a fluorescent beam from the beam splitter 133 via the second fiber 138, and divides the optical signals of the fluorescent beam having different wavelengths from each other. In the second wavelength division multiplexer 132, each optical signal is transmitted along an optical transmission path 520 corresponding to an optical channel of the optical signal. Since the fluorescent signal is weak, the second wavelength division multiplexer 132 includes a single filter 521 for each optical channel. Thereafter, the filtered fluorescent light enters a light detection element 525 (e.g., a photodiode, an avalanche photodiode (APD), a photomultiplier tube) for further processing.

Alternative suitable configurations for the wavelength division multiplexers may be used. For example, the first and second wavelength division multiplexers 131, 132 can include notch filters corresponding to the respective fluorescence channels. The notch filters can reduce or eliminate the crosstalk of the side scattered light to the fluorescence light. In this case, the beam splitter 133 may only include the dichroic mirror 532 with no notch filter 534.

In the side collection unit 130, a diameter of the collection fiber 136 may be different from diameters of the first fiber 137 and the second fiber 138 according to the light transmission efficiency. Lenses in the beam splitter may cause aberration, and thus the output light spots may be larger than input of the beam splitter, and the fiber diameters may be selected accordingly.

The forward collection unit 150 includes an obscuration bar 155, a concave mirror 151, a filter 157, and a forward detector 159. The obscuration bar 155 blocks a large portion of the light transmitted through the flow chamber 15 to reduce background noise created by the excitation light beams transmitting directly through the flow chamber 15, and to allow collection of only forward scattered light from the particles. In some examples, the majority of the transmitted light is blocked so as not to saturate the forward detector 159.

The concave mirror 151 reflects a forward scattered beam emitted from the particles. The filter 157 allows forward scattered light with a high signal-to-noise ratio to pass, and block other light. The forward detector 159 receives the filtered forward scattered light from the filter 157, and processes and analyzes the forward scattered light.

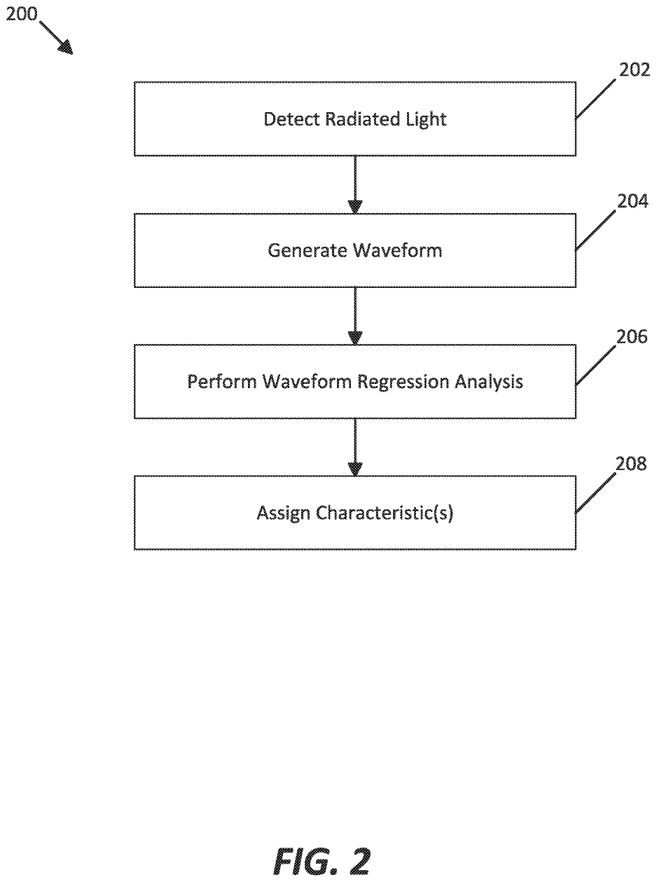

FIG. 2 schematically illustrates an example of a method 200 of characterizing particles. The method 200 can be performed by the detection system 100 to determine one or more characteristics of the particles that pass through the interrogation zone 18.

In this illustrative example, the method 200 includes an operation 202 of detecting radiated light from a particle passing through an excitation light beam in the interrogation zone 18 of the flow chamber 15. As described above, the excitation light beam is generated by the light emitting unit 110 and the radiated light is collected by the light collection unit 120. The radiated light can include both light scatter and fluorescence that results from the projection of the excitation light beam onto the particle as it passes through the interrogation zone 18.

The method 200 includes an operation 204 of generating a waveform from the radiated light detected in operation 202. The waveform is generated as a digital representation of the radiated light collected from the particle as it passes through the interrogation zone 18. In some examples, the waveform is generated in operation 204 by an analog-to-digital converter (ADC) that converts a continuous analog signal into a discrete digital signal.

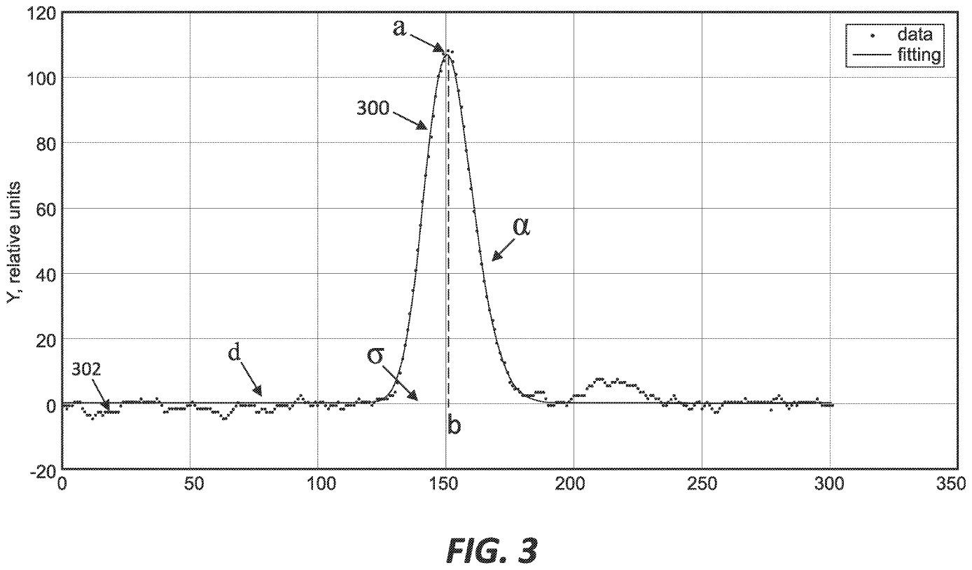

FIG. 3 illustrates an example of a waveform 300 generated in operation 204. In this illustrative example, the waveform 300 is generated based on data points 302 that include detected radiated light measured as a voltage (Y-axis) over time (X-axis). In FIG. 3, the X-axis coordinate values are bins units with 1 bin equaling 16,000 picoseconds (ps).

Referring back to FIG. 2, the method 200 includes an operation 206 of performing a waveform regression analysis on the waveform generated in operation 204 to obtain coefficients for characterizing the waveform. The waveform regression analysis fits the waveform generated in operation 204 to a skewed Gaussian model represented by Equation 1,

$$y = {ae}^{- {( \frac{x - b}{σ} )}^{2}} ( 1 + erf ( α \frac{x - b}{σ} ) ) + d \qquad ( 1 )$$

where a is an amplitude of the waveform, b is a position of the waveform, σ is a coefficient proportional to a width of the waveform, d is a baseline of the waveform, and α is a skewness of the waveform. By fitting the waveform to the skewed Gaussian model represented by Equation 1, five separate coefficients (a, b, σ, d, and α) are obtained for characterizing the waveform, with four of the five coefficients being independent coefficients. Each coefficient derived from fitting the waveform to Equation 1 can be used to identify characteristics of the particles that pass through the interrogation zone 18 of the detection system 100.

In FIG. 3, the coefficients (a, b, σ, d, and α) are shown on the waveform 300 for reference. In the illustrative example shown in FIG. 3, Table 1 summarizes the values of the coefficients of the waveform 300 when fitted to Equation 1, and their potential uses for identifying characteristics of the particles that pass through the interrogation zone 18.

TABLE 1

| Coefficient | Value | Characteristic |
|---|---|---|
| amplitude (a) | 108.21 | Relative particle size |
| position (b) | 151.89 | Fluorescence decay time |
| width scale (σ) | 17.95 | Doublets discrimination, |
| | | absolute particle size, |
| | | intracellular processes |
| baseline (d) | 0.72 | Accuracy, independency |
| | | of all coefficients |
| skewness (α) | 1.42 | Particle morphology, non- |
| | | spherical shape, cell type |

The list of coefficients and characteristics summarized in Table 1 is not comprehensive such that additional coefficients and characteristics can be obtained by fitting the waveform 300 to Equation 1. For example, an area (A) under the waveform 300 can be determined from the coefficients obtained from Equation 1, and the area (A) can be used by the detection system 100 for doublets discrimination and identifying cell granularity.

As will be described in more detail, fitting the waveform 300 to Equation 1 can reduce noise from the baseline (d), and can determine skewness of the waveform which is a characteristic typically ignored in flow cytometry. In the illustrative example of FIG. 3, the waveform 300 is skewed because in this example, the skewness (α) is equal to 1.42, and a Gaussian function has a symmetrical bell shape with skewness (α) typically less than 0.5.

Not only does fitting the waveform to Equation 1 produce additional coefficients for characterizing the particle, but fitting the waveform to Equation 1 allows the detection system 100 to analyze particles having a smaller size. For example, traditional flow cytometers are typically used to measure white blood cells having a size of about 12-15 microns. By fitting the waveform to Equation 1, new types of particles such as extracellular vesicles EVs can be analyzed, and the detection system 100 can analyze particles having sizes less than 12-15 microns. The Equation I can be executed by the detection system 100 without any modification of the hardware of the system or changing the detection sensitivity of the system.

As further shown in FIG. 2, the method 200 includes an operation 208 of assigning one or more characteristics to the particle based on the coefficients derived from Equation 1. Each of the coefficients and their associated characteristics will now be described in more detail.

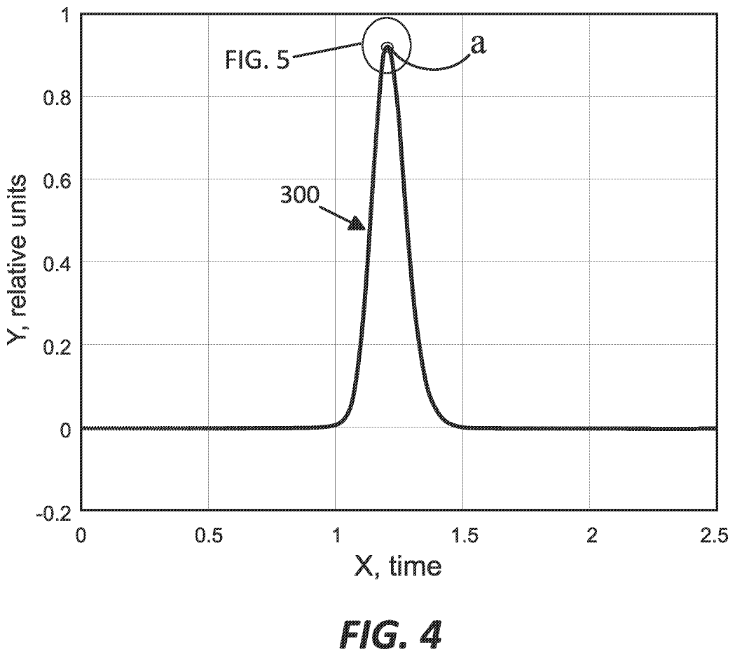

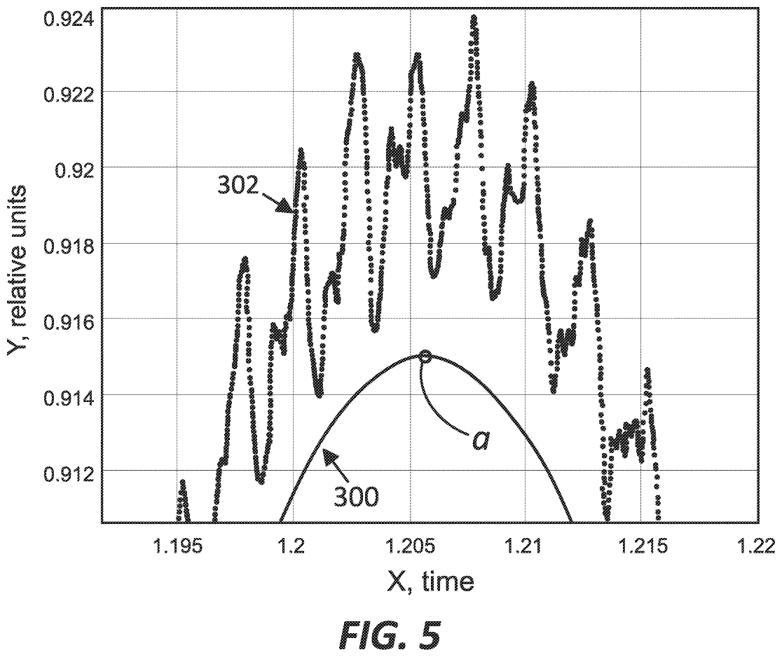

FIGS. 4 and 5 graphically illustrate an example of detecting the amplitude (a) of the waveform 300, with FIG. 5 showing a detailed view of the amplitude (a) depicted in FIG. 4. The waveform 300 is determined from the data points 302, and the waveform 300 is then fitted to Equation 1 for determining the value of the amplitude (a). As shown in Table 1, the amplitude (a) is used to characterize a relative size of the particle where a larger amplitude means a larger particle size, and conversely, a smaller amplitude means a smaller particle size.

As further shown in Table 1, the position (b) coefficient can be used to characterize a fluorescence decay time of the particle. The fluorescence decay time can be used to monitor intracellular biochemical reaction for the investigation of nanoparticle behavior in living cells.

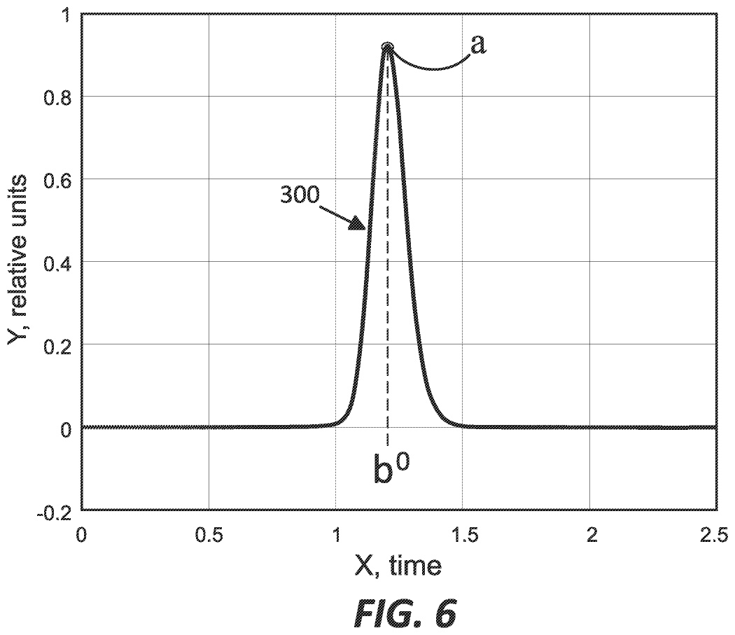

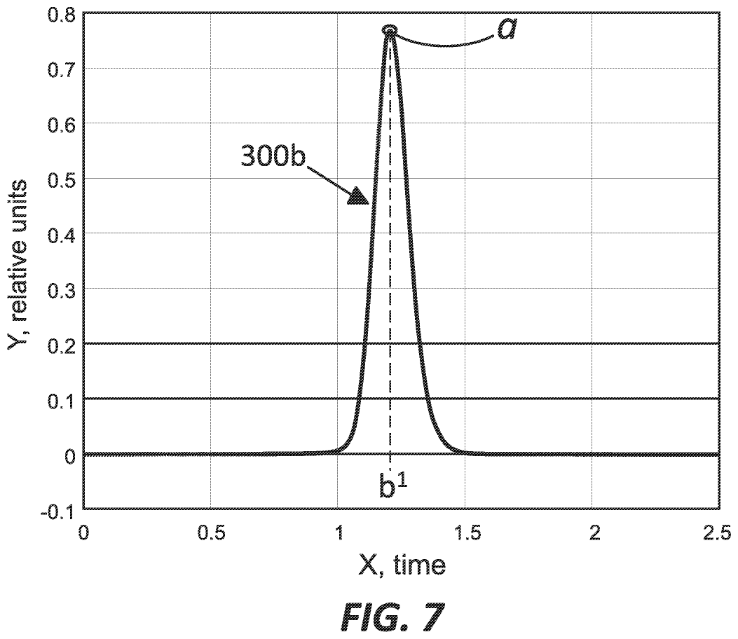

FIGS. 6 and 7 graphically illustrate an example of detecting the fluorescence decay time by using the position (b) of the waveform, with FIG. 6 showing a waveform 300a generated from a side scatter (SSC) detection channel of the detection system 100, and FIG. 7 showing a waveform 300b generated from a fluorescence (FL) detection channel of the detection system 100. Both of the waveforms 300a, 300b are generated from the same event when a particle passes through the interrogation zone 18. The fluorescence decay time is derived from a time shift between the waveforms 300a, 300b. The time shift is determined as the difference in a position (b^{SSC}, b^{FL}) between the two corresponding waveforms 300a, 300b.

In this illustrative example, the X-axis coordinate of the amplitude (a) in FIGS. 6 and 7 is used for identifying the position bSSC, bFL in the waveforms 300a, 300b. In other examples, alternative X-axis coordinates can be used for identifying the positions b^{SSC}, b^{FL}. The X-axis coordinate values are in bins units with 1 bin equaling 16,000 picoseconds (ps). In the SSC channel (FIG. 6), the position b^{SSC} equals 120570.08 bin units. In the fluorescent channel (FIG. 7), the position b^{FL} equals 120833.04 bin units. In this example, the time shift between the SSC and FL channels represented by waveforms 300a, 300b (b^{SSC}-b^{FL})*0.016 equals 4.2 nanoseconds (ns), which can be used to determine the fluorescence decay time of the particle.

Referring to Table 1, the width scale (σ) is used to determine a width of the waveform. Thereafter, the width of the waveform can be used by the detection system 100 to characterize an absolute size and/or intracellular composition of the particle, and/or to perform doublets discrimination (cell doublets which occur when two cells are fused together). For example, the width of the waveform is determined by the time of flight of the particle through the interrogation zone. Large particles will spend more time within the interrogation zone due to their size than small particles. Thus, the width of the waveform can be calibrated to determine a particle size dimension. Also, the width of the waveform can also be calibrated to perform doublets discrimination by distinguishing cell doublets from singular cells because cell doublets will have a longer time of flight through the interrogation zone due to their larger size.

The width scale (σ) can be used to determine a width of the waveform at any height. As an illustrative example, a full width at half maximum (FWHM) for a waveform having a Gaussian shape is equal to 2.3550. As a further example, the width scale (σ) can be used to determine the width of the waveform at a predetermined threshold such as 1/10 of the amplitude (a), in which case, the width of the waveform is determined by Equation 2.

$$2 σ \sqrt{ln 10} \qquad ( 2 )$$

Advantageously, the width scale (σ) as determined from Equation 1 allows a width of the waveform to be calculated independently of the amplitude (a) and without applying a threshold. This can improve the accuracy of the width determination for the waveform.

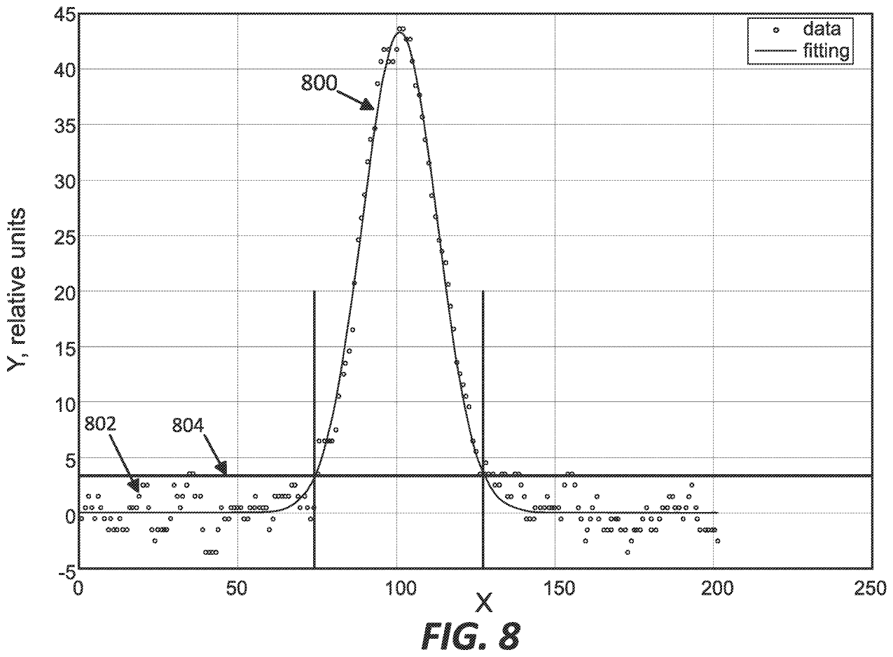

FIG. 8 graphically illustrates an example showing a threshold 804 superimposed on a waveform 800 determined from data points 802. In this illustrative example, threshold 804 is set at 1/10 of the amplitude (a) of the waveform 800. In conventional flow cytometry, the detected radiated light below the threshold 804 is ignored to reduce background noise. Also, in conventional flow cytometry, a width of the waveform is determined by the threshold 804.

In contrast to conventional flow cytometry techniques, the method 200 includes performing an analysis on the entirety of the waveform 800 including radiated light detected both above and below the threshold 804 such that the waveform 800 is characterized without distorting the waveform 800 by removing or ignoring the data points 802 below the threshold 804. Also, the width of the waveform 800 is determined without using the threshold 804. Table 2 summarizes the values of the coefficients of the waveform 300 when fitted to Equation 1.

TABLE 2

| Coefficient | Value |
|---|---|
| amplitude (a) | 43.1125 |
| position (b) | 101.1018 |
| width scale (σ) | 11.7695 |
| baseline (d) | 0.21036 |
| skewness (α) | 1.43 |

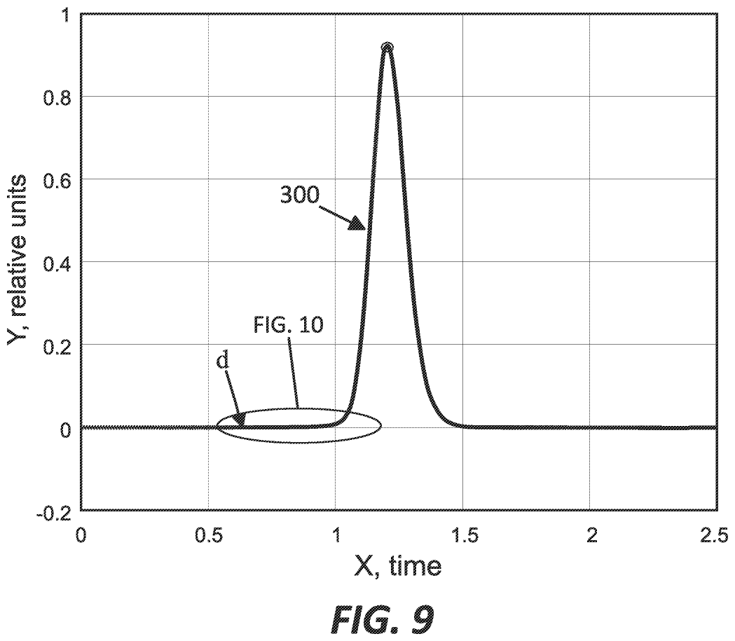

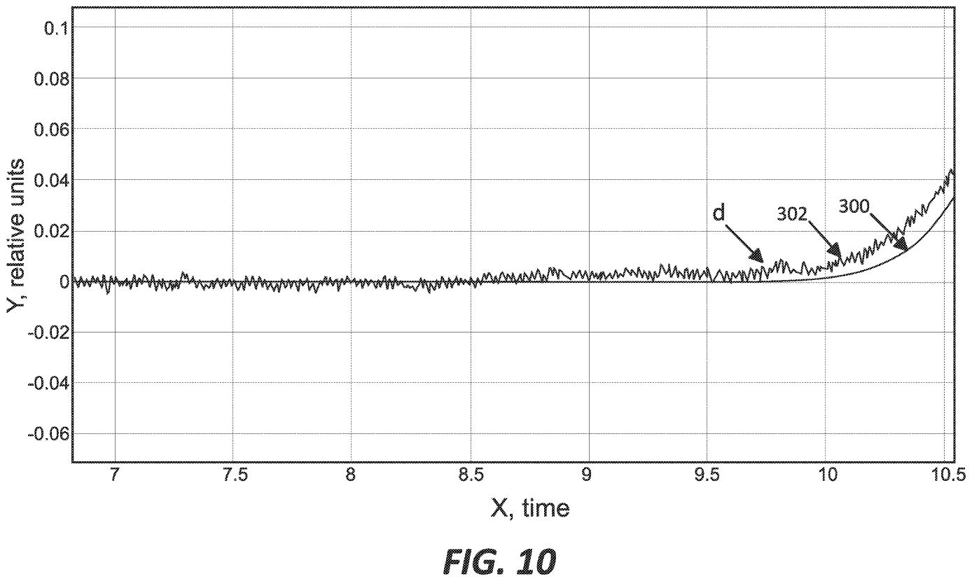

FIGS. 9 and 10 graphically illustrate an example of detecting the baseline (d) of the waveform 300, with FIG. 10 showing a detailed view of the baseline (d) depicted in FIG. 9. In the illustrative example shown in FIGS. 9 and 10, the waveform 300 is generated from data points 302 (see FIG. 10) collected from the SSC detection channel of the detection system 100. The waveform 300 is fitted to Equation 1 to determine the value of the baseline (d). As shown in Table 1, the detection system 100 can use the baseline (d) to determine an overall accuracy and independency of the other coefficients determined from fitting the waveform 300 to Equation 1. Since conventional flow cytometry typically applies a threshold to the data points 302 (see FIG. 8), the baseline (d) is not typically analyzed or used in conventional flow cytometers.

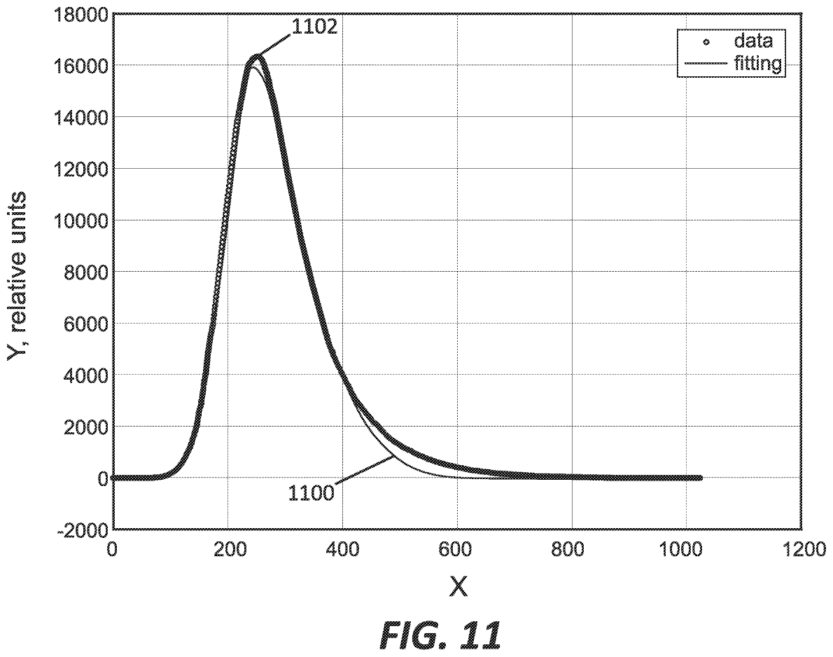

FIG. 11 graphically illustrates an example of the skewness (α) detection that includes a waveform 1100 generated from experimental data 1102 collected by the light collection unit 120 of the detection system 100. Most waveforms in flow cytometry exhibit skewness on a measurable level. However, skewness (α) is typically ignored by conventional flow cytometers. Advantageously, the detection system 100 uses the skewness (α) of the waveform 1100 to characterize a morphology, a non-spherical shape, and/or a cell type of the particle.

In the illustrative example of FIG. 11, the experimental data 1102 is plotted after subtraction of the baseline (d). A shape of a waveform or a light pulse is typically considered Gaussian (i.e., having a symmetric bell curve shape) when the skewness (α) is less than 0.5. In this example, the waveform 1100 has a skewness (α) of 3.17 such that the waveform 1100 is not Gaussian. Instead, the waveform 1100 is a skewed Gaussian waveform. For particles thar are expected to have large skewness coefficients, a quantiFlash® Calibration Light Source for Cytometry and Low Light Detectors can be used to generate the waveform 1100.

FIG. 12 schematically illustrates an example of a computing system 1200 for implementing aspects of the detection system 100. For example, the computing system 1200 can be used to fit the waveform to Equation 1 to obtain the coefficients listed above.

The computing system 1200 includes one or more processing devices 1202, a memory storage device 1204, and a system bus 1206 coupling the memory storage device 1204 to the one or more processing devices 1202. The one or more processing devices 1202 can include a processor such as a central processing unit (CPU). The one or more processing devices 1202 can include a microcontroller having one or more digital signal processors, field-programmable gate arrays, and/or other types of electronic circuits.

The memory storage device 1204 can include a random-access memory (“RAM”) 1208 and a read-only memory (“ROM”) 1210. Basic input and output logic having basic routines transferring information between elements in the detection system 100 can be stored in the ROM 1210. The detection system 100 can additionally include a mass storage device 1212 that can store an operating system 1214 and software instructions 1216. The mass storage device 1212 is connected to the one or more processing devices 1202 through the system bus 1206. The mass storage device 1212 and computer-readable data storage media provide non-volatile, non-transitory computer memory storage for the detection system 100.

Although the description of computer-readable data storage media contained herein refers to the mass storage device 1212, it should be appreciated by those skilled in the art that computer-readable data storage media can be any available non-transitory, physical device or article of manufacture from which the detection system 100 can read data and/or instructions. The computer-readable storage media can be comprised of entirely non-transitory media. The mass storage device 1212 is an example of a computer-readable storage device.

Computer-readable data storage media include volatile and non-volatile, removable, and non-removable, media implemented in any method or technology for storage of information such as computer-readable software instructions, data structures, program modules or other data. Example types of computer-readable data storage media include, but are not limited to, RAM, ROM, EPROM, EEPROM, flash memory or other solid-state memory technology, or any other medium which can be used to store information, and which can be accessed by the device.

The detection system 100 can operate in a networked environment using logical connections to the other devices through a communications network 1220. The detection system 100 connects to the communications network 1220 through a network interface unit 1218 connected to the system bus 1206. The network interface unit 1218 can also connect to other types of communications networks and devices, including through Bluetooth, Wi-Fi, and cellular telecommunications networks including 4G and 5G networks. The network interface unit 1218 can connect the detection system 100 to additional networks, systems, and devices. The detection system 100 also includes an input/output unit 1222 for receiving and processing inputs and outputs from one or more peripheral devices, and the user interface 1224.

The mass storage device 1212 and the RAM 1208 can store software instructions and data. The software instructions can include an operating system 1214 suitable for controlling the operation of the detection system 100. The mass storage device 1212 and/or the RAM 1208 can also store the software instructions 1216, which when executed by the one or more processing devices 1202, provide the functionality of the detection system 100 discussed herein.

The various embodiments described above are provided by way of illustration only and should not be construed to be limiting in any way. Various modifications can be made to the embodiments described above without departing from the true spirit and scope of the disclosure.

Embodiments of the disclosure can be described with reference to the following numbered clauses, with preferred features laid out in the dependent clauses:

1. A flow cytometer, comprising:
a light emitting unit generating an excitation light beam;
a focal lens focusing the excitation light beam at an interrogation zone;
a flow chamber for streaming particles through the interrogation zone;
a light collection unit detecting radiated light from the particles passing through the excitation light beam; and
a computing system configured to:
   generate a waveform as a digital representation of the radiated light detected from the particles passing through the excitation light beam;
   perform a waveform regression analysis on the waveform to obtain coefficients characterizing the waveform; and
   assign one or more characteristics to the particles based on the coefficients.
      2. The flow cytometer of clause 1, wherein the waveform regression analysis is performed without distorting the waveform.
      3. The flow cytometer of clause 1 or 2, wherein at least one of the coefficients includes a coefficient proportional to a width of the waveform for assigning at least one of a particle size, an intracellular distribution, and a doublets discrimination.
      4. The flow cytometer of any of clauses 1-3, wherein at least one of the coefficients includes a position coefficient for detecting a fluorescence lifetime of the particles.
      5. The flow cytometer of any of clauses 1-4, wherein at least one of the coefficients includes a skewness coefficient for discriminating cell types of the particles.
      6. The flow cytometer of clause 1, wherein the waveform regression analysis is performed to obtain an amplitude coefficient, a position coefficient, a coefficient proportional to width, a baseline coefficient, and a skewness coefficient.

1. A detection system for analyzing particles, the detection system comprising:
one or more processing devices; and
a memory storage device storing instructions which, when executed by the one or more processing devices, cause the one or more processing devices to:
detect radiated light as a particle passes through a light beam;
generate a waveform as a digital representation of the radiated light;
perform a waveform regression analysis on the waveform to obtain coefficients characterizing the waveform; and
assign one or more characteristics to the particle based on the coefficients.

2. The detection system of claim 1, wherein the waveform regression analysis is performed without distorting the waveform.

3. The detection system of claim 1, wherein at least one of the coefficients includes a coefficient proportional to a width of the waveform for assigning at least one of a particle size, an intracellular distribution, and a doublets discrimination to the particle.

4. The detection system of claim 3, wherein the coefficient proportional to the width of the waveform is determined independently of an amplitude of the waveform.

5. The detection system of claim 1, wherein at least one of the coefficients includes a position coefficient for detecting a fluorescence lifetime of the particle.

6. The detection system of claim 1, wherein at least one of the coefficients includes a skewness coefficient for discriminating a cell type of the particle.

7. The detection system of claim 1, wherein the waveform regression analysis is performed to obtain an amplitude coefficient, a position coefficient, a coefficient proportional to width, a baseline coefficient, and a skewness coefficient.

8. A method of characterizing a particle using a flow cytometer, the method comprising:
detecting radiated light as the particle passes through a light beam;
generating a waveform as a digital representation of the radiated light;
performing a waveform regression analysis on the waveform to obtain coefficients characterizing the waveform; and
assigning one or more characteristics to the particles based on the coefficients.

9. The method of claim 8, wherein the waveform regression analysis is performed without distorting the waveform.

10. The method of claim 8, wherein at least one of the coefficients includes a coefficient proportional to a width of the waveform for assigning at least one of a particle size, an intracellular distribution, and a doublets discrimination to the particle.

11. The method of claim 10, wherein the coefficient proportional to the width of the waveform is determined independently of an amplitude of the waveform.

12. The method of claim 8, further comprising:
determining a fluorescence lifetime of the particle based on changes in a position coefficient obtained from the waveform regression analysis.

13. The method of claim 8, wherein at least one of the coefficients includes a skewness coefficient for discriminating a cell type of the particle.

14. The method of claim 8, further comprising:
obtaining from the waveform regression analysis an amplitude coefficient, a position coefficient, a coefficient proportional to width, a baseline coefficient, and a skewness coefficient.
